(19) United States
(12) Patent Application Publication
(10) Pub. No.: US 2021/0302096 A1
(43) Pub. Date: Sep. 30, 2021

(54) Drying Apparatus and Method of Drying

(71) Applicant: Tyler Player, Presque Isle, ME (US)

(72) Inventor: Tyler Player, Presque Isle, ME (US)

(21) Appl. No.: 17/344,470

(22) Filed: Jun. 10, 2021

Related U.S. Application Data
(63) Continuation-in-part of application No. 16/993,853, filed on Aug. 14, 2020, now abandoned.
(60) Provisional application No. 62/887,026, filed on Aug. 15, 2019.

(51) Int. Cl. F26B 3/04; F26B 21/04; F26B 21/10; F26B 23/02

(52) U.S. Cl. CPC F26B 3/04; F26B 21/04; F26B 2210/16; F26B 23/028; F26B 21/10

(57) ABSTRACT

A process and apparatus for drying materials inside a kiln that sends heat produced from a wood burning furnace through an air-to-air heat exchanger that extracts recycled air from the kiln, heats the recycled air, and sends the recycled air back into the kiln.

### FIELD OF THE INVENTION

The invention relates to processes for drying materials, and in particular methods that use large kilns to dry wood products such as lumber.

### DISCUSSION OF PRIOR ART

In general, once a tree is felled, debarked, and cut into relatively standard and uniform sized boards, those boards must be dried so as to reduce the moisture content of the wood to a certain level before they are usable.

One of the more common methods for drying lumber is known as “kiln drying”, in which a large building or chamber is used to dry stacks of lumber in a method that is similar to that of an oven. More particularly, these large buildings are outfitted with various forms of equipment for controlling the atmosphere, namely the atmospheric temperature, relative humidity and circulation rate. The key factor to kiln drying is the manner in which the heat is circulated through the building to expedite the drying process.

This long-known process works relatively well, however, it requires a great deal of heat that requires a great deal of energy to produce, and therefore it is often a very expensive process. Additionally, the hot air that is circulated within the building must be clean air as any dirt or other particles contained in the air may stick or adhere to the wet or moist wood before it dries. Some lumber is also subject to a pressure treatment prior to being dried, which makes the issue of dirty air even more problematic.

A number of different types of systems exist for generating heat for the kilns. For example, boilers and steam coils are used to generate and deliver clean heat. However, such systems are challenging to operate, require a great deal of maintenance, and typically result in a relatively expensive approach. An alternative to boiler systems are wood burning systems. Burning wood, and in particular wood that is a waste or byproduct of the lumber making process, is often an economical source of heat for these kiln drying methods. However, conventional wood-burning systems emit ash when the wood burns and contaminate the air. When this contaminated air enters the kiln it may damage or destroy some of the valuable wood that it is intended to dry.

What is needed, therefore, is a method of efficiently and economically producing clean hot air as a part of a kiln drying apparatus.

### BRIEF SUMMARY

The invention is a method and apparatus for efficiently and economically drying materials in a kiln. The method uses a wood burning furnace to generate hot air and then an air-to-air heat exchanger to heat air that is circulated through the kiln and recycled back into the air-to-air heat exchanger to be reheated.

The wood burning furnace is a conventional device that is configured to deliver a consistent level of hot air, for example, air that is heated to approximately 700 to 1000 degrees Fahrenheit and that varies by no more than 100 degrees Fahrenheit during any hour of operation. The furnace produces this hot air by burning numerous forms of wood and wood byproduct, which is a relatively inexpensive manner of producing hot air. The hot air is pulled out of the furnace and run through an air-to-air heat exchanger. As the hot air exits the furnace it is likely to be dirty air, meaning it contains some amount of ash and other combustion products. Separately, the cooled air inside of the kiln is pulled out of the kiln and into the air-to-air heat exchanger to be reheated and sent back into the kiln as recycled air.

The air-to-air heat exchanger separates the hot dirty air from the furnace and the clean recycled air from the kiln. After the dirty air and recycled air pass through the exchanger the clean hot recycled air then goes to the kiln where it circulates in a conventional manner and dries the materials contained within. The air-to-air heat exchanger also cools the hot dirty air from the furnace as a part of its conventional process, for example, if the hot air that exits the furnace and enters the air-to-air heat exchanger is approximately 800 degrees Fahrenheit the recycled air that enters the kiln is likely to be to approximately 400 degrees Fahrenheit. One or more fans, such as a hot air induced draft fan, assists the movement of the hot air through the apparatus.

Conventional conduits convey the hot air from the furnace and into the kiln, with the conduit that is attached to the kiln located on an upper portion of a sidewall. A second fan is connected to the kiln at a lower portion of a sidewall. As the hot air in the kiln circulates, it naturally cools over time, and as hot air continues to be provided inside the kiln the cooler air is drawn out through the second fan. The cooled air is then directed back in to the air-to-air heat exchanger where it is blended with the hot air from the furnace and reheated after which is goes back into the kiln.

### BRIEF DESCRIPTION OF THE DRAWINGS

The present invention is described with reference to the accompanying drawings. In the drawings, like reference numbers indicate identical or functionally similar elements. The drawings are not drawn to scale.

FIG. 1 is a flow chart that illustrates the steps in the method.

FIG. 2 is a front view of an apparatus used in practicing the method having one wood burning furnace and two kilns.

FIG. 3 is a top view of an apparatus used in practicing the method.

FIG. 4 is a top view of the apparatus not connected to kilns.

FIG. 5 is a side view of the air-to-air heat exchanger and two fans connected to a kiln.

FIG. 6 is a front view of the apparatus not connected to a kiln.

### DETAILED DESCRIPTION OF THE INVENTION

The present invention will now be described more fully in detail with reference to the accompanying drawings, in which the preferred embodiments of the invention are shown. This invention should not, however, be construed as limited to the embodiments set forth herein; rather, they are provided so that this disclosure will be complete and will fully convey the scope of the invention to those skilled in the art.

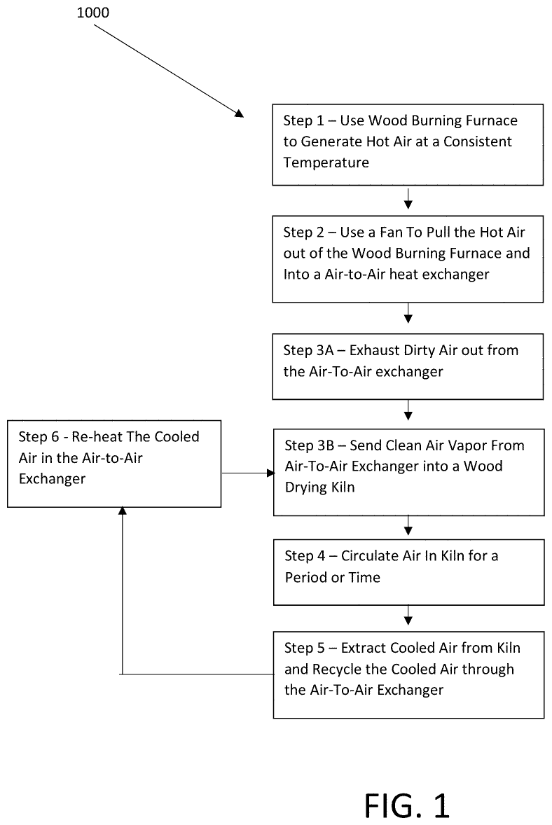

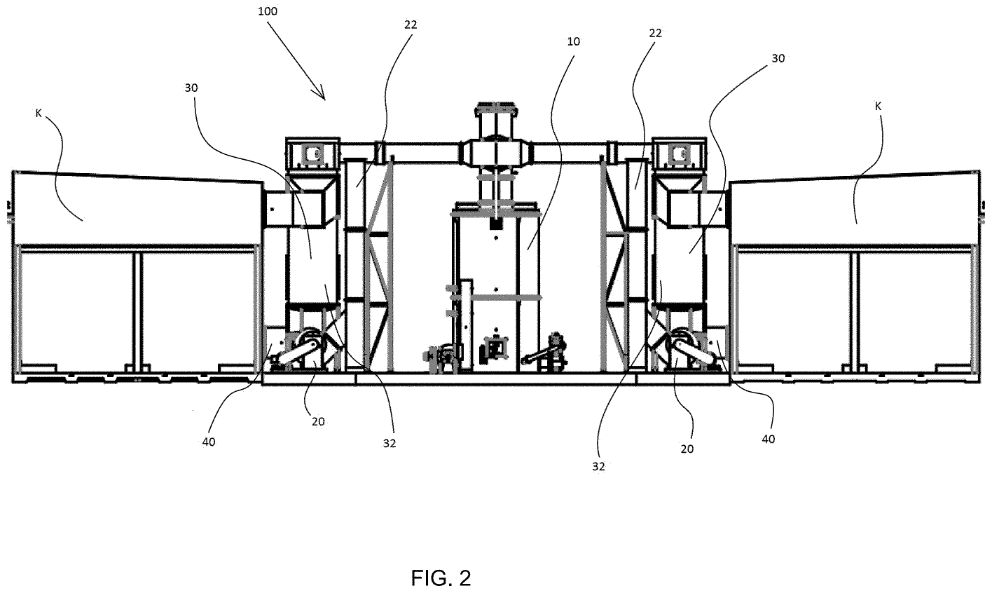

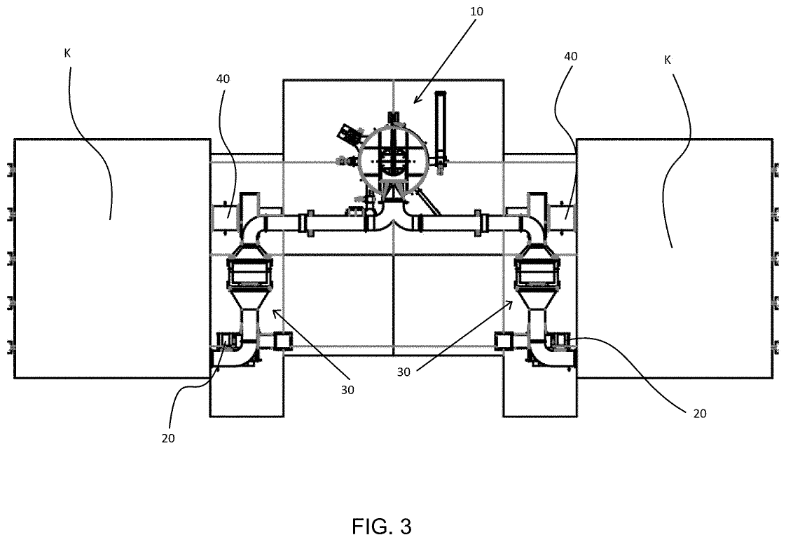

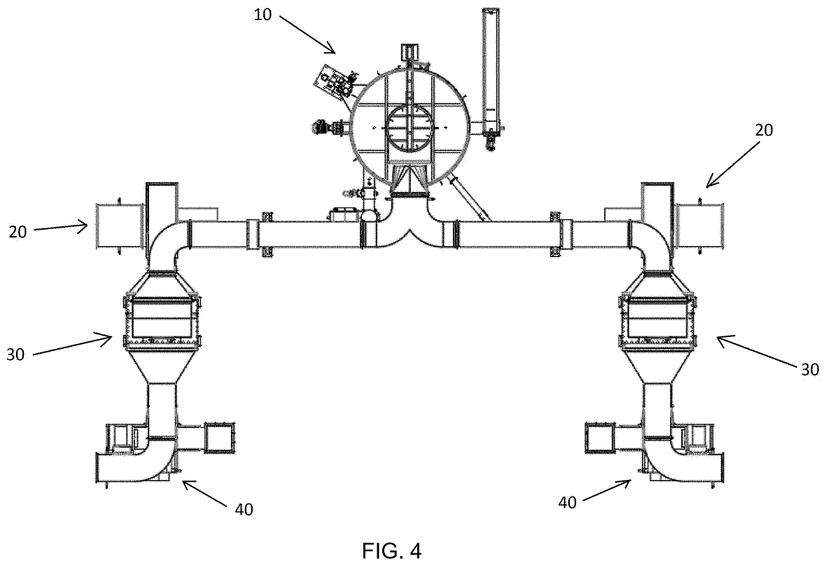

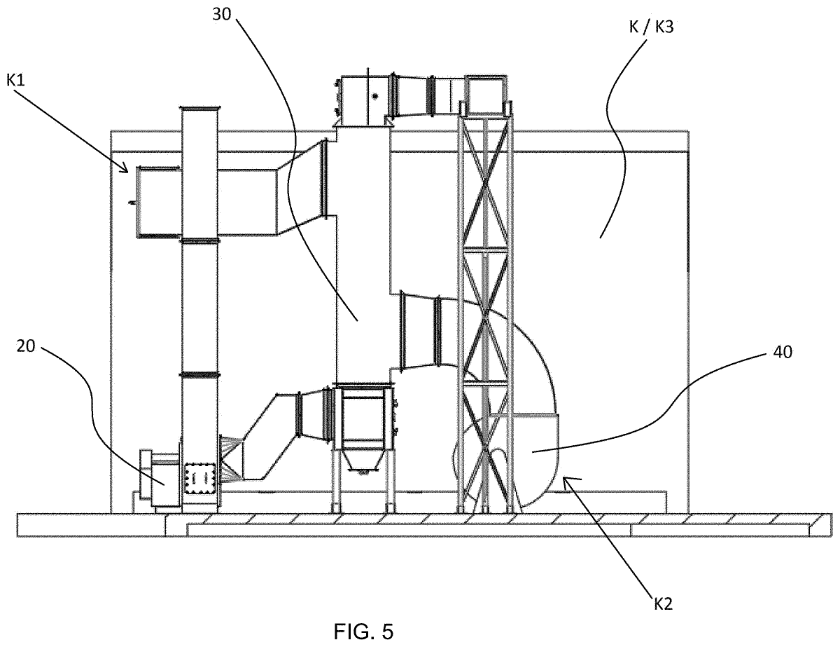

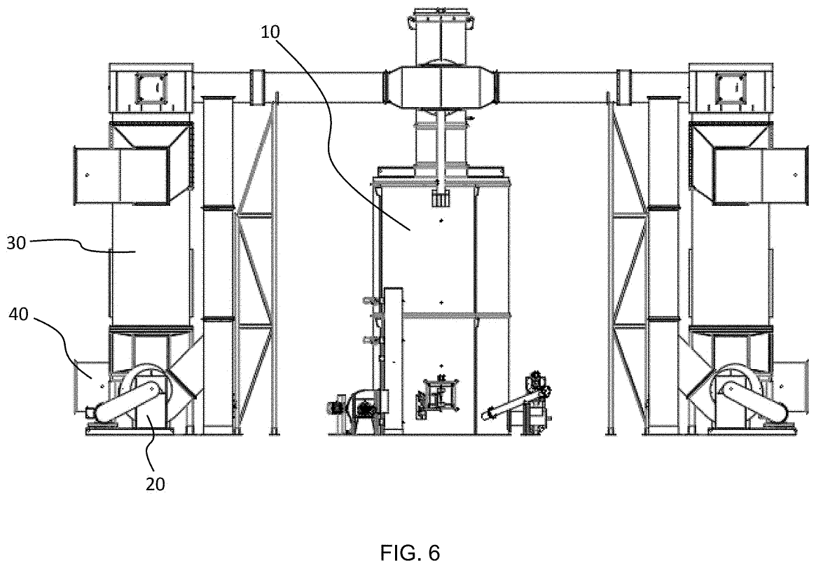

FIG. 1 illustrates a method of drying lumber 1000 that uses a drying apparatus 100 shown in FIGS. 2-6. In general, the method 1000 uses a wood burning furnace 10 to generate hot air that moves through an air-to-air heat exchanger 30, the air-to-air heat exchanger 30 transfers heat from the furnace air to the kiln air, and the hot air is circulated in the kiln K where it dries the contents. The hot air circulates throughout the kiln K and over time it becomes cooled air which point the cooled air pulled out of the kiln K by one or more exhaust fans and directed back into the heat exchanger 30 where the cooled air is reheated and sent back into the kiln K. The process blends the heat within the air-to-air heat exchanger 30 and produces a consistent level of hot air that does not foul or otherwise damage components within the apparatus while effectively drying wood in the kiln K. The furnace 10, air-to-air heat exchangers 30, and kiln K are connected to one another using conventional piping and related components.

The embodiment shown in the drawings illustrates a drying apparatus 100 having single furnace 10 connected to two air-to-air heat exchangers 30 that are connected to two separate kilns K, however, this is only an example. The apparatus performs equally well with a single furnace 10 connected to a single air-to-air heat exchanger 30 that is connected to a single kiln K. Other configurations using different numbers of furnaces 10, air-to-air heat exchangers 30, and kilns K, also perform well.

More specifically, the hot air that the wood burning furnace 10 generates contains ash and other combustion particles and therefore exits the furnace as dirty hot air and is directed into the air-to-air heat exchanger 30. The clean but cool air that is in the kiln is pulled out of the kiln and sent into the air-to-air heat exchanger to be reheated and sent back to the kiln as hot recycled air. In its conventional manner, the air-to-air heat exchanger keeps separate the dirty hot air from the furnace and the clean hot vapor from the kiln. The clean hot vapor is then directed into the kiln K through standard piping that extends from the air-to-air exchanger 30 to a high entry location K1 on the kiln K. The clean vapor is cooler than the heat emitted by the furnace 10 due to the effects of the heat exchanger 30, but it is still hot enough to be an effective heat source within the kiln K. The dirty air is exhausted out of the heat exchanger 30 and into the atmosphere through a chimney 22.

The apparatus 100 utilizes at least two fans 20, 40, to move air throughout the apparatus 100. The first fan 20 pulls the heat out of the furnace 10 through conventional piping 12 and into the heat exchanger 30. The heat is consistently blended within the air-to-air heat exchanger 30 in a manner that keeps the temperature of the air within the kiln within the range of approximately 100 to 500 degrees Fahrenheit, e.g. 400 to 500 degrees upon entry and 100 to 250 degrees as it cools and before it exits the kiln K. The kiln K uses standard conventional components to circulate the air and dry the contents of the kiln K.

The second fan 40 is connected to the kiln K at a low point K2 on the side of a wall K3 and performs two primary functions. First, the fan 40 helps to pull heat out of the air-to-air heat exchanger and into the kiln K. As the clean hot air passes through the air-to-air heat exchanger it naturally rises and enters the kiln K, however, the action of the second fan pulling air out of the kiln K also has the effect of pulling hot air out of the air-to-air heat exchanger 30 and into the kiln K. Second, as the air circulates within the kiln K it cools by heating up and drying the lumber in the kiln K and is eventually extracted from the kiln K by the second fan 40 and directed back into the air-to-air heat exchanger 30. The extracted air is reheated and sent back into the kiln K as recycled air.

The apparatus 100 and method 1000 may use a conventional or custom-built wood burning furnace 10 to burn wood and generate hot air. However, it is important that the furnace 10 is capable of generating a consistent level of heat. Specifically, the temperature should not vary by more than 100 degrees Fahrenheit during any hour of operation. One suitable furnace is, for example, a 25 million British thermal unit per hour (25 MM BTU/hr) furnace from Player Design, Inc., which is capable of consistently generating heat in the area of 800 degrees Fahrenheit while being fed numerous forms of wood and wood byproduct. Generating a consistent level of heat in the range of 700-1000 Fahrenheit is important for long-term and efficient performance of the apparatus 100 as varying levels of heat may damage or foul the air-to-air heat exchanger 30.

The fans 20, 40, are conventional fans that are suitable for this application. For example, a hot air induced draft (“ID”) fan is particularly advantageous for use in the apparatus 100 as they are designed to pull hot flue gases from a furnace and they have a chimney 22 to vent dirty air out of the apparatus and into the atmosphere.

The air-to-air heat exchanger 30 is a conventional device that is typically used to cool the interior temperature of a building or enclosed structure by bringing hot air within the structure down to ambient temperature. The mechanical details and methodology behind air-to-air heat exchangers are well known.

As one example, the air-to-air heat exchanger 30 uses a “shell and tube” design that is configured such that a relatively large number of hollow tubes are configured to receive the hot air from the furnace 10 while recycled air from the Kiln K is brought into the shell, around the hollow tubes, and kept separate from hot air inside the tubes. The hot air from the furnace 10 passes through the tubes and is exhausted out of the air-to-air exchanger while the recycled air from the kiln K passes through the shell and around the tubes and is heated by the high temperature of tubes. Conventional tubing conveys the heat from the furnace 10 to the hollow tubes, and similarly conventional tubing coveys the recycled air from the kiln to the shell and back to the kiln.

For example, with the system disclosed herein the furnace 10 may send hot air into the heat exchanger 30 at roughly 900 degrees Fahrenheit while the recycled air from the Kiln K may enter the shell at a temperature of roughly 200 degrees Fahrenheit; as the recycled air passes through the shell and around the tubes the heated tubes increase the temperature of the recycled air to a temperature of roughly 400 degrees Fahrenheit. In this embodiment when the system commences the heat exchanger 30 is provided with hot air from the furnace 10 and air from the kiln k such that the air passing through the heat exchanger 30 and into the kiln k is recycled air that has passed through the kiln k.

There are many manufacturers of suitable air-to-air heat exchangers, for example, PRE-HEAT INC of Oostbury Wis. makes a number of suitable models including their Air-to-Air Industrial Shell & Tube ALT-inmate Heat Exchanger.

More specifically, in the apparatus 100 the process within the air-to-air heat exchanger 30 cools the hot air from the furnace in the normal course of the exchange process, however, due to high entry temperature of the hot air being pulled into the air-to-air heat exchanger 30 from the furnace 10 the recycled air that exits the exchanger 30 still becomes hot enough to be useful as drying air inside the kiln. For example, if the dirty hot air that enters the exchanger is around 800 degrees Fahrenheit, the reheated recycled air that enters the kiln is in the range of 350 to 450 degrees Fahrenheit, often approximately 400 degrees. Similarly, if the dirty air is in a range of 700 degrees Fahrenheit to 1000 degrees Fahrenheit this process would produce recycled air at a temperature in the 300 to 500 degrees Fahrenheit range.

Inside the kiln there are a number of conventional fans (not shown) that circulate the clean hot air. Conventional fan motors FM are provided outside the kiln K to power the fans. Typically, the air that enters the kiln is around 400 degrees Fahrenheit and it circulates inside the kiln K until it drops in temperature to the 100-250 degree Fahrenheit level at which point it is pulled out by the recycling fan 40 and fed back into the heat exchanger 30 where it is heated back to the 300-500 degree range.

The time to dry lumber varies widely based on the type and amount of the contents in the kiln, as it does with any conventional kiln drying process. For example, with hardwood it may take as long as a week whereas with softwood it may only take 30 to 50 hours depending on the amount.

It is understood that the embodiments described herein are merely illustrative of the present invention. Variations in the construction of, or steps in, the process and apparatus for drying lumber may be contemplated by one skilled in the art without limiting the intended scope of the invention herein disclosed and as defined by the following claims.

What is claimed is:

1: A process for drying materials in a kiln, the process comprising the steps of:
Using a wood burning furnace to generate hot air;
Using a fan to pull recycled air out of the kiln;
Sending the hot air and the recycled air into an air-to-air heat exchanger; and
Sending the recycled air back into the kiln as it exits the air-to-air heat exchanger.

2: The process of claim 1, further comprising the steps of:
Using a first fan to pull the hot air out of the wood burning furnace and into the air-to-air heat exchanger.

3: The process of claim 2, further comprising the step of using a second fan to pull the recycled air out of the air-to-air heat exchanger and into the kiln.

4: The process of claim 3, wherein the second fan is connected to the kiln and extracts the recycled air from the kiln.

5: The process of claim 4 further comprising the step of:
sending the recycled air into the air-to-air heat exchanger.

6: The process of claim 5, further comprising the step of:
exhausting the hot air out of the air-to-air heat exchanger.

7: The process of claim 1, wherein the wood burning furnace generates a consistent level of heat that is between approximately 700 degrees Fahrenheit and 1000 degrees Fahrenheit.

8: The process of claim 1, wherein the recycled air is approximately between 300 degrees Fahrenheit and 500 degrees Fahrenheit as it enters the kiln.

9: The process of claim 4, wherein the air is between approximately 100 degrees Fahrenheit and 250 degrees Fahrenheit when it is extracted from the kiln.

10: The process of claim 3 wherein the first fan and second fan are each hot air induced draft fans.

11: A drying apparatus adapted to dry materials in a kiln, the drying apparatus comprising:
a wood burning furnace that is connected to an air-to-air heat exchanger, the wood burning furnace configured to provide hot air to the air-to-air heat exchanger;
the air-to-air heat exchanger connected to the kiln and configured to extract recycled air out of the kiln, heat the recycled air, and return the recycled air to the kiln.

12: The drying apparatus of claim 11, further including a first fan that is connected to the air-to-air heat exchanger and that pulls the hot air out of the wood burning furnace and into the air-to-air heat exchanger.

13: The drying apparatus of claim 12, further including a second fan that is connected to the kiln and to the air-to-air heat exchanger, the second fan pulling the recycled air out from the kiln and sending it into the air-to-air heat exchanger.

14: The drying apparatus of claim 13, wherein the air-to-air heat exchanger is connected to the kiln at an upper portion of a wall of the kiln.

15: The drying apparatus of claim 14, wherein the second fan is connected to the kiln at a low portion of the wall of the kiln.

16: The drying apparatus of claim 11, wherein the hot air provided by the wood burning furnace has a temperature that varies by no more than 100 degrees Fahrenheit in any hour of operation.

17: The drying apparatus of claim 11, wherein the hot air from the wood burning furnace has a temperature between approximately 700 degrees Fahrenheit and approximately 1000 degrees Fahrenheit.

18: The drying apparatus of claim 11, wherein the recycled air has a temperature between 300 and 500 degrees Fahrenheit as it enters the kiln.

19: A drying apparatus adapted to dry materials in a plurality of kilns, the drying apparatus comprising:
at least one wood burning furnace that is connected to a plurality of air-to-air heat exchangers, the number of air-to-air heat exchangers being equal to or greater than the number of kilns, at least one of the air-to-air heat exchangers from the plurality of air-to-air heat exchangers connected to each of the kilns in the plurality of kilns;
wherein the wood burning furnace provides hot air to the plurality of air-to-air heat exchangers;
wherein the plurality of air-to-air heat exchangers each extract recycled air from the respective kilns, heat the recycled air, and send the recycled air back into the kiln.
